(19) United States
(12) Patent Application Publication
(10) Pub. No.: US 2025/0034409 A1
(43) Pub. Date: Jan. 30, 2025

(54) FLOOR FINISH COMPOSITION

(71) Applicant: S. C. Johnson & Son, Inc., Racine, WI (US)

(72) Inventors: Carmine SAVAGLIO, Kenosha, WI (US); Ana F. LONGORIA, Mount Pleasant, WI (US); Michael M. FRYD, Oak Creek, WI (US); Xiaomang WANG, Lake Bluff, IL (US)

(21) Appl. No.: 18/784,818

(22) Filed: Jul. 25, 2024

Related U.S. Application Data
(60) Provisional application No. 63/529,545, filed on Jul. 28, 2023.

(51) Int. Cl. C09D 7/47; C08K 5/06; C08K 5/3415; C08L 25/14; C08L 71/12; C08L 91/06; C09D 5/02; C09D 7/20; C09D 7/63; C09D 7/65; C09D 125/14

(52) U.S. Cl. CPC C09D 7/47; C08K 5/06; C08K 5/3415; C08L 25/14; C08L 71/126; C08L 91/06; C09D 5/024; C09D 7/20; C09D 7/63; C09D 7/65; C09D 125/14; C08K 2201/007; C08K 2201/019

(57) ABSTRACT

A composition for a floor finish is disclosed that includes at least one silicone polyether surfactant, at least one nonionic surfactant, and at least one resin. In certain embodiments the composition is free or substantially free of fluorochemicals.

### CROSS-REFERENCE TO RELATED APPLICATIONS

The present application claims priority to U.S. Patent Application No. 63/529,545 filed on Jul. 28, 2023, the entire contents of which is hereby incorporated by reference.

### BACKGROUND

### 1. Technology Field

The present disclosure relates to a floor finish composition and, more particularly, to a fluoro-free composition that matches or exceeds the properties of compositions that include fluorosurfactants.

### 2. Description of the Background

A floor polish, finish, or coating composition is a temporary coating that enhances the appearance and protects the substrate (e.g., a floor) to which it is applied. Numerous benefits to users exist in using an effective floor polish or finish, including wear protection of the flooring surface, easier cleaning of porous flooring, improved aesthetics of the facility the flooring is in, and a consistent walking surface (e.g., consistent Coefficient of Friction).

There are many factors that define a quality floor finish, of which one of the most important is the “ease of application” that allows the end-user to achieve the desired result regardless of a required application tool or skill. This benefit is critically dependent on how consistently the wet film spreads upon application to the floor to yield a smooth and glossy film, and to do so for multiple coats, in order to achieve the desired aesthetics. The initial coat must self-level, or else any disturbances or undulations will persist in subsequent coats. Such floor compositions should avoid phase changes (e.g., state, composition, or otherwise) that can induce liquid flow, surfactant flow, or repartitioning. Other undesirable effects from unsatisfactory floor compositions can manifest as macroscale surface defects such as orange peel, craters, streaks, Benard cells, picture framing, spotting, or phase separation.

As stated, it is desirable that floor finishes, and most particularly the initial coating of the floor finish, self-level while drying. Otherwise, any undulations will “freeze” in the initial coat and other subsequent coats will be affected by the uneven level of the floor finish. During the drying process, self-levelling issues compound as a result of the floor polish or coating changing from a largely hydrophilic liquid state into a hydrophobic solid state, and during such process, the floor polish must remain level after it solidifies. As floor polish or finish compositions have many different ingredients and interfaces, there are many hinderances that make it difficult to have the desired smooth finish. Important interfaces that have the potential to drive difference in the look of the final floor finish—which will be impacted by surfactants, solvents, plasticizers, and polymers, as well as phase changes (e.g., state, composition, or otherwise)—include, but are not limited to: the liquid-substrate interface; the liquid-air interface; the liquid-solid interface; the polymer-bulk liquid interface; and the plasticizer-bulk liquid interface. The difference in these interfaces and differences in phase changes (such as state, composition, or otherwise) can induce liquid flow, surfactant flow-repartitioning, and other effects that manifest defects at a macroscale. Some of these defects include orange peel, craters, streaks or “mop lines,” benard cells, picture framing, spotting, or phase separation. Simply put, leveling of a typical floor polish or composition is a complex process and depends on a variety of different facts.

Fluorosurfactant compounds, e.g., polyfluoroalkyl substances (PFAS), are common and typically critical components in prior art floor polish formulations. Fluorosurfactants are primarily used to generate wetting and leveling effects, and because of this have been the industry standard in providing this benefit due to their excellent performance at low concentrations. However, there is a desire to provide alternatives to fluorosurfactants and to identify replacements for PFAS chemistries used in floor finishing that either match or outperform the performance of fluorosurfactant compounds. With that said, to date, there are no drop-in replacements that can match the performance provided by this class of chemical. As such, it has been difficult to provide a suitable replacement in order to increase market flexibility and to address declining public perception of fluorochemicals.

The difficulty, in part, resides in the fact that there are many factors that prohibit good wetting of a floor finish, leading to poor performance with regard to case of application. For example, water has a very high surface tension and tends to pull back on itself, leading to bare spots and uneven coating thickness. Hydrophobic polymers and waxes tend to exhibit streaking and dulling. Floor surfaces vary greatly in composition and cleanliness, leading to a wide variety of conditions that any floor finish must perform well on. Fluorosurfactants are effective at lowering surface tension and do so at very low concentrations, which has historically been beneficial. This effectiveness allows for broad usage of fluorosurfactants with a variety of different floor polish formulas despite those formulas being quite different in composition.

Finding a replacement for fluorosurfactants in coating compositions has been a difficult task, as any replacement must be capable of lowering surface tension at low concentrations, be broadly applicable, provide long term film performance, and be cost-effective. Thus, there remains a need for floor finish compositions that do not include fluorosurfactants, but that maintain the benefits that users expect, such as ease of application, longevity, and aesthetics.

### SUMMARY

The subject matter described herein relates to compositions for finishing floors. The compositions include finishing products that are free or substantially free of fluorinated chemicals.

Accordingly, an advantage of the present disclosure is that the compositions of the present disclosure provide a floor finish composition that includes wetting and leveling aids that are free of fluorosurfactants. Further, compositions of the present disclosure also provide a floor finish composition that meets or exceeds user expectations for aesthetics and ease of application for multiple coats. Additionally, the compositions of the present disclosure also provide a broadly applicable replacement for fluorosurfactants in floor finish compositions.

In one embodiment disclosed herein is a composition for a floor finish that includes a polymer, a surfactant, and a resin. In further embodiments, the polymer is a polyether modified polysiloxane, the surfactant is a non-ionic surfactant, and the resin is an alkaline soluble resin. In even further embodiments, the nonionic surfactant is a capryl pyrrolidone or a polyethylene glycol monoundecyl ether, and the resin is a styrene-acrylic oligomer with an average molecular weight of 20,000 Da or less.

According to another aspect, another composition for a floor finish is provided. Here, the composition includes at least one silicone polyether surfactant, at least one nonionic surfactant, and at least one resin.

According to yet another aspect of the present disclosure, another composition for a floor finish is provided. In this embodiment, the composition includes at least one silicone polyether surfactant, at least one nonionic surfactant, and at least one resin. Further, the composition is substantially free of fluorosurfactants.

According to another aspect of the present disclosure, another composition for a floor finish is provided. In this embodiment, the composition includes a mixture that includes one or more surfactants and a resin. Further, the composition is substantially free of fluorosurfactants, and a leveling testing value of the composition is comparable to a control composition identical to the composition, except for the use of a fluorosurfactant.

### BRIEF DESCRIPTION OF THE DRAWINGS

FIG. 1 shows a general structure of a silicone polyether surfactant molecule; and

FIG. 2 shows various applications of silicone surfactants.

### DETAILED DESCRIPTION

Before any embodiments of the invention are explained in detail, it is to be understood that the invention is not limited in its application to the details of construction and the arrangement of components set forth in the following description or illustrated in the following drawings and/or examples. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures. The figures, which are not necessarily to scale, depict selected embodiments and are not intended to limit the scope of embodiments of the invention. Skilled artisans may also recognize that the examples provided herein have many useful alternatives and fall within the scope of embodiments of the invention.

The present disclosure is directed toward a floor finish composition free of or substantially free of fluorochemicals. While the present disclosure may be embodied in many different forms, several specific embodiments are discussed herein with the understanding that the present disclosure is to be considered only as an exemplification of the principles of the disclosure, and it is not intended to limit the disclosure to the embodiments illustrated.

The term “about,” as used herein, refers to variation in the numerical quantity that may occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture. In one embodiment, the term “about” refers to a range of values ±5% of a specified value.

All ranges disclosed herein are inclusive (including the end values of the ranges) and combinable, and the values expressed as ranges include each value within the range.

In the present invention, the singular forms “a”, “an” and “the” include the corresponding plural references, and reference to a particular numerical value includes at least that particular value, unless the context clearly dictates otherwise. Thus, for example, reference to “a substance” is a reference to at least one such substance and equivalents thereof.

As used herein, the term “essentially free of” or “substantially free of” may mean that the indicated material (e.g., a fluorosurfactant) is present in an amount of no more than 0.01 wt. % by weight of a composition (e.g., floor finish composition), or preferably not present at an analytically detectible level in such compositions. It may also include compositions where the indicated material is present only as an impurity of one or more of the materials deliberately added to such compositions.

The term “ready-to-use,” as used herein, refers to compositions which are meant to be used as-is without dilution. Further, the term “ready-to-use,” may also refer to a dilution of a concentrate.

The term “weight percent,” “wt-%,” “percent by weight,” “% by weight,” and variations thereof, as used herein, refer to the concentration of a substance as the weight of that substance divided by the total weight, for example, of the composition or of a particular component of the composition, and multiplied by 100. It is understood that, as used herein, “percent,” “%,” and the like may be synonymous with “weight percent” and “wt-%.”

The compositions described herein include water. The term “water” may include, without limitation, deionized (DI) or any other water suitable for the composition.

The term “hydrophobic glycol solvent,” as used herein, refers to any glycol ether solvent that has a solubility in water of about 0.1 to about 20% by weight at 25° C., 1 atm and an evaporation rate of about 1 mm Hg or less or, more preferably, with an evaporation rate of about 0.1 mm Hg or less.

In one embodiment disclosed herein, a formulation comprises a silicone, a surfactant, and a resin mixture that mimics a fluorosurfactant and its ability to minimize any leveling or wetting defects. As will be discussed herein, the wetting aid or surfactant mixture of the present disclosure can be a substitute to fluorosurfactants. In one particular embodiment, the mixture includes three components: a polymer, a surfactant, and a resin. Further, it has been shown that floor coating compositions that include this replacement mixture mimic or exceed the properties or characteristics of floor coating compositions including fluorosurfactants. These properties or characteristics include the floor coating composition's ability to minimize surface tension or concentration-induced flow, surface tension reduction to wet out multiple substrates, appropriate surface energy to wet out on subsequent coats, the ability to repartition to aid in all stages of levelling, and the ability to ensure optimal packaging of an emulsion polymer for smooth fusion into a level film.

In further embodiments, the polymer is a polyether modified polysiloxane, the surfactant is a non-ionic surfactant, and the resin is an alkaline soluble resin. In even further embodiments, the nonionic surfactant is a capryl pyrrolidone or a polyethylene glycol monoundecyl ether, and the resin is a styrene-acrylic oligomer with an average molecular weight of 20,000 Da or less.

The compositions of the present disclosure may also include additional components beyond the wetting aid mixture. In particular, the compositions of the present disclosure may also include a carrier or dilutant, such as water; one or more solvents; one or more plasticizers; one or more polymers, polymer emulsions, or polymer solutions; one or more waxes; and a fragrance.

### Fluorosurfactant Substitute System

As discussed, the present disclosure provides a system or mixture of components that may be used in substitute for fluorosurfactants, and in particular, fluorosurfactants in floor finish compositions. The fluorosurfactant substitute system may include one or more surfactants, as well as a resin solution.

### Surfactant(s)/Wetting Aid(s)

The surfactant(s) of the present disclosure may include one or more of the surfactants discussed herein. The term “surfactant,” as used herein, refers to a chemical compound that lowers the interfacial tension between two liquids. Some surfactants, also known as wetting aids, allow water-based solutions to spread over or “wet” a surface, increasing the contact between the solution and the surface, and thus improving the coating of the surface by the solution.

The floor finish composition may include at least one surfactant in an amount ranging from about 0.001 wt. % to about 5 wt. %, about 0.05 wt. % to about 0.25 wt. %, and preferably in an amount ranging from about 0.01 wt. % to about 2 wt. %, and most preferably in an amount ranging from about 0.05 wt. % to about 1 wt. %. In particular embodiments, the surfactants are individually about 0.1 wt. % of the floor finish composition.

The surfactant may be a nonionic surfactant. Nonionic surfactants may refer to surfactants where the molecules forming the surfactant are uncharged. Nonionic surfactants may include, but are not limited to, long chain alcohols, such as, for example, fatty alcohols, cetyl alcohol, stearyl alcohol, cetostearyl alcohol (consisting predominantly of cetyl and stearyl alcohols), undecanol, and oleyl alcohol. Nonionic surfactants may include, but are not limited to, polyoxyethylene glycol alkyl ethers —CH₃—(CH₂)₁₀₋₁₆—(O—C₂H₄)₁₋₂₅—OH, such as octaethylene glycol monododecyl ether, pentaethylene glycol monododecyl ether, or polyethylene glycol monoundecyl ether (CAS #34398-01-1). Examples of polyethylene glycol monoundecyl ether are undeceth-3 (CAS #88299-47-2), undeceth-5 (CAS #34398-01-1), and undeceth-7 (CAS #127036-24-2). Nonionic surfactants may also include polyoxypropylene glycol alkyl ethers CH₃—(CH₂)₁₀₋₁₆—(O—C₃H₆)₁₋₂₅—OH. Nonionic surfactants may also include glucoside alkyl ethers —CH₃—(CH₂)₁₀₋₁₆—(O-Glucoside)₁₋₃-OH, such as decyl glucoside, lauryl glucoside, and octyl glucoside. Nonionic surfactants may further include polyoxyethylene glycol octylphenol ethers —C₈H₁₇—(C₆H₄)—(O—C₂H₄)₁₋₂₅—OH, such as Triton X-100, from Sigma Aldrich. Nonionic surfactants may also include polyoxyethylene glycol alkylphenol ethers —C₉H₁₉—(C₆H₄)—(O—C₂H₄)₁₋₂₅—OH, such as Nonoxynol-9. Nonionic surfactants may further include glycerol alkyl esters such as glyceryl laurate. Nonionic surfactants may also include polyoxyethylene glycol sorbitan alkyl esters (e.g., polysorbate), sorbitan alkyl esters (e.g., spans), cocamide MEA, cocamide DEA, dodecyldimethylamine oxide, block copolymers of polyethylene glycol and polypropylene glycol (e.g., poloxamers), or polyethoxylated tallow amine (e.g., POEA). Nonionic surfactants may also include caprylyl pyrrolidone (CAS #60437-60-7). Another nonionic surfactant includes 1-octyl-2-pyrrolidone (CAS #2687-94-7). A particular nonionic surfactant that may be used in the floor finish composition is the Easy-wet™ 20 wetting agent supplied by Ashland Inc. (8145 Blazer Dr, Wilmington, Delaware 19808), which comprises N-octyl-2-pyrrolidone, 1 undecanol, polyethylene glycol monoundecyl ether, and sodium lauryl sulfate.

The floor finish composition of the present disclosure may also include a silicone surfactant. Silicone surfactants refer to a surfactant having a chemical structure that includes a silicon-oxygen chain. Silicone surfactants can be effective wetting agents, are known to minimize defects, and limit foaming. One example of a general molecular structure of silicone surfactants are shown here:

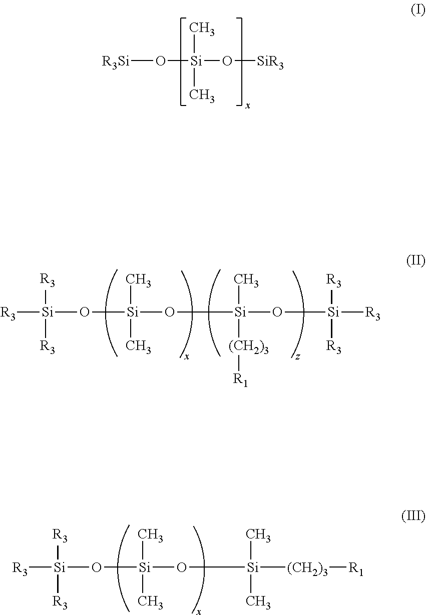

The di-methyl monomer, defined by brackets annotated by X, provides typical silicone properties such as reduction of surface tension and increase of surface slip. The higher the number of di-methyl monomers (i.e., a higher value of X), the stronger the silicone. R₃ may include methyl. R₁ may include cationic functional groups (e.g., alkyl quaternary ammonium compounds, amido quaternary ammonium compounds, or imidazoline derivative quaternary ammonium compounds), anionic functional groups (e.g., phosphate ester salt, sulfate salt, carboxylate salt, sulfonate salt, or sulfosuccinamide ester), nonionic functional groups (e.g., polyether, alkanolamide, ester, or glycoside), or amphoteric functional groups (e.g., phosphate betaine or betaine).

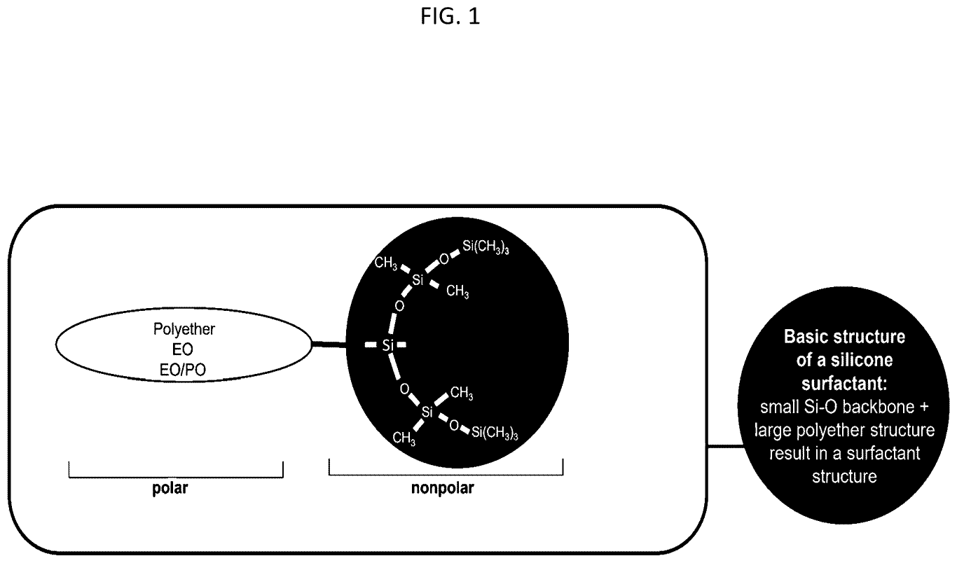

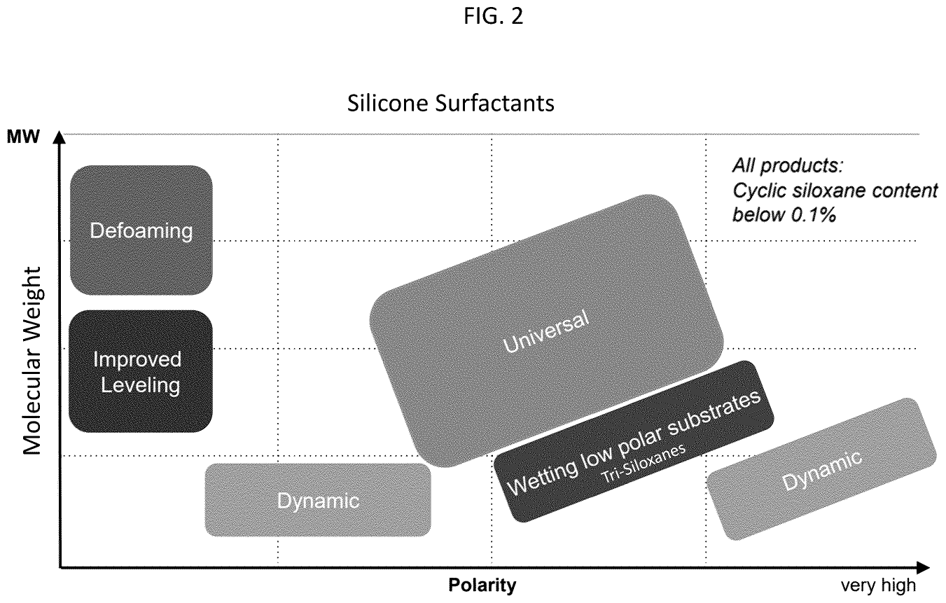

Non-polar silicone chains may be conjugated with a polar polymer to form a silicone surfactant, for example, an ethylene oxide (EO) polymer or a propylene oxide (PO) polymer, to form a silicone polyether (SP) surfactant. A general structure representing one possible form of an SP surfactant having a non-polar end and a polar end is shown in FIG. 1. Silicone surfactants may include variations in molecular weight and polarity based on the silicone chain and the polar chain, which may vary in length and type. Silicone and SP surfactants can be effective for defoaming, improved leveling, and wetting non-polar surfaces (see FIG. 2).

Examples of commercially available silicone-containing surfactants that may be used in the present disclosure as wetting aids include, but are not limited to, Siltech C570 (Siltech Corp., 225 Wicksteed Avenue. Toronto, Ontario. Canada. M4H 1G5), a polyether-modified polydimethylsiloxane BYK 3455 (BYK-Chemie GmbH, Abelstrasse 45, 46483 Wesel, Germany), a low molecular weight nonionic silicone polyether surfactant Sylgard OFX 0309 (DOW Chemicals, 2211 H.H. Dow Way Midland, MI 48674), and Hydropalat WE 3225 (BASF Corporation, 11501 Steel Creek Road Charlotte, NC 28273), and/or combinations thereof.

In particular embodiments, the composition of the present disclosure includes a surfactant mixture that includes at least one polyether silicone and at least one nonionic surfactant. It has been surprisingly found that a surfactant mixture including at least one polyether silicone and at least one nonionic surfactant provides optimal properties and characteristics, including the same or better leveling performance and low streak defects after numerous coatings, that meet or exceed the properties and characteristics provided by compositions having fluorosurfactants. Additionally, the surfactants were used or implemented in the compositions in relatively low concentrations, which can also be a beneficial aspect of the compositions of the present disclosure.

### Resin

In addition to the aforementioned surfactants, the compositions of the present disclosure may also include a resin, such as an alkaline soluble resin with an average molecular weight of 20,000 Da or less. A resin may provide a desired strength to a composition. In particular embodiments, the fluorosurfactant substitute system of the present disclosure includes an alkali soluble resin solution (e.g., styrene acrylic oligomers), and in even further embodiments, this resin includes an average molecular weight of 20,000 Da or less. These resins may be included in the composition in an amount ranging from about 1 wt. % to about 15 wt. %, or from about 3 wt. % to about 10 wt. %, or from about 5 wt. % to about 10 wt. %, or from about 6 wt. % to about 9 wt. %, or from about 7 wt. % to about 8.5 wt. %, or from about 7.5 wt. % to about 8.5%. In one specific embodiment, the resin solution is in an amount of about 7.8 wt. %. In other embodiments, this resin solution is in an amount from about 1 wt. % to about 5 wt. %, or from about 2 wt. % to about 3 wt. %. Further, in one specific embodiment, the resin solution is in an amount of about 2.5 wt. %.

The compositions of the present disclosure may also include additional resins. For example, additional resins that may be included in the floor finish composition include a polymer emulsion under the trade name RHOPLEX™ 1531. In another embodiment, an amine salt modified styrene-acrylic copolymer under the trade name Joncryl ECO 75 (BASF) may be included as a resin component. In yet another embodiment, B-31 may be used as an alkali soluble styrene acrylic alkali-soluble resin with an average molecular weight of 20,000 Da or less.

### Other Components

The compositions of the present disclosure may also include additional components beyond the fluorosurfactant substitute system. In particular, the compositions of the present disclosure may also include a carrier or dilutant, such as water; one or more solvents; one or more plasticizers; one or more polymers, polymer emulsions, or polymer solutions; one or more waxes; and a fragrance.

### Carrier

Water and other carriers or dilutants may be present in the floor finish composition. The compositions herein will typically incorporate water, and more particularly, deionized water, in concentrations of at least about 30% by weight, and most preferably in amounts ranging from about 40% to about 50% by weight. In particular embodiments, water may be present in a concentration from about 30 wt. % to about 50 wt. %, or from about 35 wt. % to about 45 wt. %, or from about 35 wt. % to about 40 wt. %, or from about 40 wt. % to about 45 wt. %. In specific embodiments, the concentration of water is about 37.4 wt. % or 44 wt. %. Conditioned water or tap water may also be used in the floor finish composition.

### Solvents and Hydrophobic Solvents

The composition may further comprise at least one solvent. In a particular embodiment, the at least one solvent comprises a glycol solvent. And, in one particular embodiment, the at least one solvent and/or the glycol solvent comprises a hydrophobic glycol solvent. In one embodiment, the at least one solvent is in an amount of about 0.05 wt. % to about 10 wt. %, or more specifically about 4 wt. % to about 9 wt. %, or even more specifically about 5 wt. % to about 8 wt. % based on a total weight of the composition. In an embodiment, the at least one solvent is a combination of solvents, and the combination of solvents is in an amount of about 0.05 wt. % to about 10 wt. %, or more specifically about 4 wt. % to about 9 wt. %, or even more specifically about 5 wt. % to about 8 wt. % based on a total weight of the composition. As mentioned, the at least one solvent preferably comprises a hydrophobic glycol solvent. In an embodiment, the at least one solvent is selected from diethylene glycol monoethyl ether, ethylene glycol phenyl ether, ethylene glycol N-hexyl ether, and any combination of any two or more thereof.

In another embodiment, the composition may comprise other exemplary glycol solvents including, but not limited to, glycol ether based solvents based on ethylene or propylene glycol such as ethylene glycol, propylene glycol, diethylene glycol ethyl ether, dipropylene glycol methyl ether, diethylene glycol methyl ether, diethylene glycol propyl ether, diethylene glycol butyl ether, ethylene/diethylene glycol 2-ethylhexyl ether, ethylene glycol phenyl ether, dipropylene glycol propyl ether, dipropylene glycol butyl ether, propylene glycol phenyl ether, ethylene glycol hexyl ether, and/or blends thereof. The hydrophobic glycol solvents may also include glycol ethers based on benzyl alcohols and/or other similar alcohols. There are many suitable commercially available glycol solvents, for example DE Carbitol, Dowanol EPH, Hexyl Cellosolv, and any combinations thereof.

In another embodiment, other hydrophobic solvents may be used as a substitute to the hydrophobic glycol solvent. Exemplary hydrophobic solvents may include a phthalate-based solvent. Phthalate based solvents may include, but are not limited to, dibutyl phthalate, butyl benzyl phthalate, diethyl phthalate, and/or combinations thereof.

In a preferred embodiment, the at least one solvent, and more particularly the at least one hydrophobic solvent, may provide properties similar to a plasticizer. Further, in a preferred embodiment, the hydrophobic solvents provide minimal to no solid contents to the compositions. As such, the hydrophobic solvent may mimic the properties of a plasticizer, yet may evaporate and, as a result, may not compromise the strength of the composition.

In another embodiment, the solvents may comprise pyrrolidone based solvents such as 2-pyrrolidone, N-methyl-2-pyrrolidone, N-octyl-2-pyrrolidone, N-dodecyl-2-pyrrolidone, or any other suitable solvent and/or combinations thereof. The solvent system may also optionally include 2,2,4-trimethyl-1,3-pentanediol diisobutyrate.

### Polymer/Polymer Emulsion

One or more polymers or polymer emulsions may also be present in compositions of the present disclosure. Polymers or polymer emulsions may provide a desired flexibility to a composition applied therein. In one embodiment, the at least one polymer or polymer emulsion is in an amount of about 20 wt. % to about 60 wt. %, or more specifically about 25 wt. % to about 50 wt. %, or even more specifically about 30 wt. % to about 40 wt. % based on a total weight of the composition. In specific embodiments, the polymers or polymer emulsions may be present in an amount from about 35 wt. % to about 40 wt. %, or may be present in an amount of about 35.4 wt. % or about 38 wt. %.

Further, the polymer or polymer emulsion may have a solids content in an amount of about 10 wt. % to about 40 wt. %, or more specifically about 10 wt. % to about 30 wt. %, or even more specifically about 11 wt. % to about 16 wt. % based on a total weight of the polymer.

In a particular embodiment, the polymer may be an acrylic polymer emulsion. Suitable acrylic polymers may include, but are not limited to polymers, copolymers, or terpolymers of acrylic acid or methacrylic acid with esters of acrylic or methacrylic acid, hydroxyethyl methacrylate methacrylonitrile, and acrylonitrile. Additional monomers may also be used. For example, additional monomers may include methyl methacrylate, butyl acrylate, ethyl acrylate, and 2-ethylhexyl acrylate. Further, additional unsaturated acid monomers may be substituted in part for the methacrylic acid. Suitable unsaturated acid monomers may include, but are not limited to, maleic acid, crotonic acid, fumaric acid, and itaconic acid.

The polymer may also comprise a vinyl component. The vinyl component may be a styrene or a monoalkenyl aromatic monomer such as methyl styrene or tertiary butyl styrene. In a specific embodiment, the acrylic polymer emulsion comprises a styrene.

As mentioned, the polymer emulsion may also be provided as a copolymer. Suitable copolymers include, but are not limited to, styrene/butyl acrylate/methacrylic acid, styrene/ethyl acrylate/methacrylic acid, styrene/butyl acrylate/ethyl acrylate acid, and styrene/butyl acrylate acrylate/ethyl methacrylic acid.

Other suitable polymers include, but are not limited to, styrene/butyl acrylate/acrylate/acrylic acid, styrene/ethyl acrylate/acrylic acid, and methyl/styrene styrene/butyl acrylate/ethyl acrylate/methacrylic acid/acrylic acid.

In another embodiment, the polymer is acid functional and is provided as a zinc cross-linked styrene-acrylic copolymer emulsion. Examples of commercially available polymers that may find use herein include for example, DURAPLUS™ 3, DURAPLUS™ 3LO, and RHOPLEX™ E-3392 or RHOPLEX™ 1531 from The Dow Chemical Company, Mor-Glo 8 from OMNOVA Solutions Inc., 25435 Harvard Road Beachwood, Ohio 44122-6201, or Joncryl® 8615 from BASF Corporation. Zinc can be post-added to commercially available polymers that lack zinc.

In a further embodiment, the acrylic polymer emulsion has an average particle size of about 1 nm to about 10 μm or, more specifically about 10 nm to about 500 nm, or even more specifically about 50 nm to about 150 nm. In a particular embodiment, the acrylic polymer emulsion has an average particle size of less than about 150 nanometers.

### Plasticizer

In general, plasticizers may increase the plasticity or fluidity of a material. As a result, a relatively high level of plasticizer may result in a soft and weak film or coating. Alternatively, a relatively low level of plasticizer may create a brittle coating. Therefore, in light of the experimentation disclosed herein, the plasticizers may be preferably incorporated in the floor finish compositions in amounts ranging from about 0.5 wt. % to about 5 wt. %, or more specifically about 1 wt. % to about 4.5 wt. %, or even more specifically about 3 wt. % to about 4 wt. % based on a total weight of the composition.

Particularly preferred plasticizers for use herein are benzoate esters and/or a tributoxy ethyl phosphate. Other suitable plasticizers may also include glycol ether dibenzoates based on ethylene or propylene glycols including, but not limited to, propylene glycol dibenzoate, dipropylene glycol dibenzoate, polypropylene glycol dibenzoate, ethylene glycol dibenzoate, diethylene glycol dibenzoate, triethylene glycol dibenzoate, polyethylene glycol dibenzoate, neopentyl glycol dibenzoate, and the like, as well as isodecyl benzoate, dipropylene glycol monomethyl ether benzoate, 2,2,4-trimethyl-1,3-pentanediol diisobutyrate, and combinations thereof. There are many suitable plasticizers available commercially, including KP-140.

In one embodiment the at least one plasticizer comprises a benzoate ester plasticizer. In a particular embodiment, the benzoate ester plasticizer has a formula PhCO (O) R₁, where Ph represents a phenyl radical and R₁ represents a linear or branched hydrocarbon radical comprising six or less carbon atoms.

In one embodiment, the benzoate ester plasticizer is a diethylene glycol dibenzoate. For example, the benzoate ester plasticizer may be Benzoflex™ 2088 (Eastman Chemical Company, 200 S. Wilcox Dr. Kingsport, TN 37660). In one embodiment, the plasticizer may be TXIB™ (trimethyl pentanyl diisobutyrate) from Eastman Chemical Company.

Suitable benzoate ester plasticizers may further include a monobenzoate. The monobenzoate may be present in the composition when the monobenzoate is not completely converted to dibenzoate. In particular, monobenzoates may include, but are not limited to, diethylene glycol monobenzoate, triethylene glycol monobenzoate, dipropylene glycol monobenzoate, and/or a combination of any two or more thereof. In one embodiment, the benzoate ester plasticizer comprises less than about 5% of a diethylene glycol monobenzoate based on a total weight of the benzoate ester plasticizer.

### Waxes/Wax Emulsion

The composition may further include an at least one wax and/or wax emulsion used in combinations herein in amounts ranging from about 1 wt. % to about 10 wt. %, and more preferably in amounts ranging from about 1 wt. % to about 6 wt. % based on a total weight of the compositions. In specific embodiments, the wax or wax emulsion is in an amount from about 5 wt. % to about 6 wt. %.

As noted, the composition may further comprise at least one wax or wax emulsion. Suitable waxes include, without limitation, plant, e.g., vegetable, animal, insect, synthetic and/or mineral waxes. Specific examples of suitable waxes include, but are not limited to, candelilla wax, Fisher-Tropsch wax, oxidized petroleum wax, microcrystalline waxes, lanolin wax, wax derived from cocoa butter, cottonseed wax, stearin wax, Japan wax, bayberry wax, myrtle wax, wax derived from mace, palm kernel wax, beeswax, spermaceti, Chinese insect wax, wax made from mutton tallow, polyethylene waxes, oxidized polyethylene waxes, polypropylene waxes, oxidized polypropylene waxes, waxes based on copolymers or propylene and acrylic acid and/or methacrylic acid and/or maleic anhydride, waxes based on copolymers of ethylene and acrylic esters and/or maleic anhydride, waxes based on copolymers of ethylene and acrylic acid and/or methacrylic acid and/or maleic anhydride, waxes based on copolymers of ethylene and styrene and/or other vinyl monomers, waxes obtained from the hydrogenation of coconut oil or soybean oil, and mineral waxes such as paraffin, ceresin, montan, ozokerite, and the like.

Examples of commercially available waxes that may be used in the present disclosure include, but are not limited to, non-ionic polypropylene emulsion—E-43 Wax (Michem 94340 available from the Michelman Company, 9080 Shell Road Cincinnati, OH 45236-1299), high density polyethylene wax emulsion—AC-316 wax emulsion (MorFlo-WE30, available from OMNOVA), and an alkaline polyethylene-acrylic graft emulsion (Syntran PA-1475, available from Zschimmer & Schwarz Interpolymer Inc., 800 South Main Street Suite 204 Mansfield, MA 02048), and/or combinations thereof. In one embodiment, the wax or wax emulsion may be present in the floor finish composition in an amount between about 0.25% to about 3% based on percent solids.

### Other Components

The composition may further include an anti-foaming agent or a defoamer in an amount ranging from about 0.001 wt. % to about 1 wt. % and most preferably in an amount ranging from about 0.001 wt. % to about 0.3 wt. %. Suitable anti-foaming agents may include, without limitation, insoluble oils, polydimethylsiloxanes emulsions and dispersions and other silicones, certain alcohols, stearates, and glycols. Specifically, suitable anti-foaming agents may include Wacker Silfoam® SE-21, SE-24, and SD-168 (available from Wacker Chemie AG, Hanns-Seidel-Platz 4 81737 Munich Germany), BYK® 024 available from BYK, and AGITAN® 786 (available from MÜNZING, 1455 Broad Street, 3rd Floor Bloomfield, NJ 07003).

The composition may further include a fragrance in an amount ranging from about 0.001 wt. % to about 1 wt. %, and most preferably in an amount ranging from about 0.001 wt. % to about 0.01 wt. %. The term “fragrance,” as used herein, may generally refer to any water soluble fragrance substance or mixture of such substances including those which are naturally derived, for example, obtained by extraction of flower, herb, blossom or plant, those which are artificially derived or produced, for example, a mixture of natural oils and/or oil constituents, and those which are synthetically produced substances, for example, odiferous substances. Suitable fragrances may also include, without limitation, commercially available fragrances.

As previously mentioned, the composition, as disclosed herein, provides a floor finish composition that is free of fluorochemicals. The particular compositions disclosed herein exhibit a synergy between three components, polyether-modified polysiloxane, nonionic surfactants (e.g., caprylyl pyrrolidone and a polyethylene glycol monoundecyl ether), and alkaline soluble resins (e.g., styrene-acrylic oligomers) that may provide a self-leveling floor finish with superior wear performance and gloss as compared to other finishes that include fluorinated compounds. The floor finish composition as disclosed herein has the ability to minimize surface tension or concentration-induced flow. Reduced surface tension imparts the capability to wet multiple substrates, has a surface energy that allows it to wet subsequent coats, has the ability to repartition to aid in all stages of levelling, and has the ability to ensure optimal packing of the emulsion polymer for smooth fusion into level film.

In a particular embodiment, the floor finish composition is in the form of a ready-to-use product. Therefore, in another embodiment, a method of finishing floors may be described and may include contacting the floor with the composition as described herein.

It will be appreciated by those skilled in the art that while the invention has been described above in connection with particular embodiments and examples, the invention is not necessarily so limited, and that numerous other embodiments, examples, uses, modifications, and departures from the embodiments, examples, and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

### EXAMPLES

The examples are intended to illustrate certain embodiments of the floor finish composition to one of ordinary skill in the art and should not be interpreted as limiting in the scope of the disclosure set forth in the claims. The composition may comprise the following non-limiting examples.

### Example 1

Table 1 lists several compositions that were tested to develop the present floor finish composition. The numerical entries in Table 1 are weight percentages of the specific chemicals in each respective composition, based on the total composition weight. That being said, the following eight compositions, i.e., Compositions 1-8, were produced, as shown below, and subsequently used in relative performance testing as described herein.

Referring to Table 1, Compositions 1-8 vary in the chemical ingredients. In particular, Compositions 2 and 3 include Resin Solution and one of Wetting Aid 1 or Wetting Aid 2. Compositions 4-6 include Wetting Aid 1, Wetting Aid 2, or both Wetting Aid 1 and Wetting Aid 2, but no Resin Solution. Composition 7 includes Resin Solution but no wetting aids. Composition 8 includes Wetting Aid 1, Wetting Aid 2, and Resin Solution.

Table 2 lists the compositions and the specific chemicals used in Compositions 1-8 as a percent solid. For instance, after application of Composition 2 to a floor, approximately 79.71% of the composition evaporates, leaving approximately 20.29% of the composition on the floor applied thereto. As a result, Composition 2 has a composition solid percent and/or percent solid of 20.29%. Table 3 lists the specific chemicals used in a control composition for comparison to Compositions 1-8.

As mentioned above, the chemical ingredients can be selected from the components listed and described herein. For instance, Plasticizer 1 may be a benzoate ester, a tributoxy ethyl phosphate, and/or a glycol ether dibenzoate based on ethylene or propylene glycols including, but not limited to, propylene glycol dibenzoate, dipropylene glycol dibenzoate, polypropylene glycol dibenzoate, ethylene glycol dibenzoate, diethylene glycol dibenzoate, triethylene glycol dibenzoate, polyethylene glycol dibenzoate, neopentyl glycol dibenzoate, and the like, as well as isodecyl benzoate, dipropylene glycol monomethyl ether benzoate, 2,2,4-trimethyl-1,3-pentanediol diisobutyrate, combinations thereof, or any other plasticizer disclosed herein. Therefore, in order to encompass the range of embodiments, the chemical ingredients have been described by general and specific terminology in Tables 1-4 and should not be limited to any specific chemical. On that basis, it should be understood that many chemicals, as disclosed herein, may provide the desired properties of the floor finish.

TABLE 1
Chemical components (wt. %) of Compositions 1-8.
Composition Weight Percentages

| Chemical Name | 1 | 2 | 3 | 4 | 5 | 6 | 7 | 8 |
|---|---|---|---|---|---|---|---|---|
| Water (deionized) | 46.111 | 43.511 | 43.511 | 43.911 | 46.011 | 46.011 | 43.611 | 43.411 |
| Solvent 1 (diethylene glycol | 5.62 | 5.62 | 5.62 | 5.26 | 5.62 | 5.62 | 5.62 | 5.62 |
| ethyl ether) | | | | | | | | |
| Plasticizer 1 (tributoxyethyl | 1.25 | 1.25 | 1.25 | 1.25 | 1.25 | 1.25 | 1.25 | 1.25 |
| phosphate) | | | | | | | | |
| Plasticizer 2 (Benzoate ester | 1.75 | 1.75 | 1.75 | 1.75 | 1.75 | 1.75 | 1.75 | 1.75 |
| blend: Diethylene Glycol | | | | | | | | |
| Dibenzoate and Dipropylene | | | | | | | | |
| Glycol Dibenzoate and | | | | | | | | |
| Triethylene Glycol | | | | | | | | |
| Dibenzoate Blend) | | | | | | | | |
| Polymer Emulsion 1 | 38.089 | 38.089 | 38.089 | 38.089 | 38.089 | 38.089 | 38.089 | 38.089 |
| (styrene acrylic co polymer | | | | | | | | |
| emulsion) | | | | | | | | |
| Wax Emulsion 1 (maleated | 1.875 | 1.875 | 1.875 | 1.875 | 1.875 | 1.875 | 1.875 | 1.875 |
| polypropylene wax | | | | | | | | |
| emulsion) | | | | | | | | |
| Wax Emulsion 2 (oxidized | 3.60 | 3.60 | 3.60 | 3.60 | 3.60 | 3.60 | 3.60 | 3.60 |
| polyethylene wax emulsion) | | | | | | | | |
| Solvent 2 (ethylene glycol | 0.8 | 0.8 | 0.8 | 0.8 | 0.8 | 0.8 | 0.8 | 0.8 |
| phenyl ether) | | | | | | | | |
| Solvent 3 (ethylene glycol | 0.7 | 0.7 | 0.7 | 0.7 | 0.7 | 0.7 | 0.7 | 0.7 |
| hexyl ether) | | | | | | | | |
| Antifoam (silicone | 0.005 | 0.005 | 0.005 | 0.005 | 0.005 | 0.005 | 0.005 | 0.005 |
| emulsion) | | | | | | | | |
| Wetting Aid 1 (polyether | — | — | 0.1 | 0.1 | 0.1 | — | — | 0.1 |
| silicone) | | | | | | | | |
| Resin Solution (low | — | 2.5 | 2.5 | — | — | — | 2.5 | 2.5 |
| molecular weight, styrene | | | | | | | | |
| acrylic alkali-soluble resin) | | | | | | | | |
| Wetting Aid 2 (Mixture: 1- | — | 0.1 | — | 0.1 | — | 0.1 | — | 0.1 |
| octyl-2-pyrrolidone, undecyl | | | | | | | | |
| alcohol + 5 EO | | | | | | | | |
| polyethoxylated, 1- | | | | | | | | |
| undecanol) | | | | | | | | |
| Fragrance (perfume) | 0.2 | 0.2 | 0.2 | 0.2 | 0.2 | 0.2 | 0.2 | 0.2 |

TABLE 2
Solid percentages of Compositions 1-8.
Composition Solid Percentages

| Chemical Name | 1 | 2 | 3 | 4 | 5 | 6 | 7 | 8 |
|---|---|---|---|---|---|---|---|---|
| Water (deionized) | 0.00 | 0.00 | 0.00 | 0.00 | 0.00 | 0.00 | 0.00 | 0.00 |
| Solvent 1 (diethylene glycol | 0.00 | 0.00 | 0.00 | 0.00 | 0.00 | 0.00 | 0.00 | 0.00 |
| ethyl ether) | | | | | | | | |
| Plasticizer 1 (tributoxyethyl | 1.25 | 1.25 | 1.25 | 1.25 | 1.25 | 1.25 | 1.25 | 1.25 |
| phosphate) | | | | | | | | |
| Plasticizer 2 (Benzoate ester | 1.75 | 1.75 | 1.75 | 1.75 | 1.75 | 1.75 | 1.75 | 1.75 |
| blend: Diethylene Glycol | | | | | | | | |
| Dibenzoate and Dipropylene | | | | | | | | |
| Glycol Dibenzoate and | | | | | | | | |
| Triethylene Glycol | | | | | | | | |
| Dibenzoate Blend) | | | | | | | | |
| Polymer Emulsion 1 | 14.474 | 14.474 | 14.474 | 14.474 | 14.474 | 14.474 | 14.474 | 14.474 |
| (styrene acrylic co polymer | | | | | | | | |
| emulsion) | | | | | | | | |
| Wax Emulsion 1 (maleated | 0.75 | 0.75 | 0.75 | 0.75 | 0.75 | 0.75 | 0.75 | 0.75 |
| polypropylene wax | | | | | | | | |
| emulsion) | | | | | | | | |
| Wax Emulsion 2 (oxidized | 1.26 | 1.26 | 1.26 | 1.26 | 1.26 | 1.26 | 1.26 | 1.26 |
| polyethylene wax emulsion) | | | | | | | | |
| Solvent 2 (ethylene glycol | 0.00 | 0.00 | 0.00 | 0.00 | 0.00 | 0.00 | 0.00 | 0.00 |
| phenyl ether) | | | | | | | | |
| Solvent 3 (ethylene glycol | 0.00 | 0.00 | 0.00 | 0.00 | 0.00 | 0.00 | 0.00 | 0.00 |
| hexyl ether) | | | | | | | | |
| Antifoam (silicone | 0.0048 | 0.0048 | 0.0048 | 0.0048 | 0.0048 | 0.0048 | 0.0048 | 0.0048 |
| emulsion) | | | | | | | | |
| Wetting Aid 1 (polyether | 0.00 | 0.00 | 0.1 | 0.1 | 0.1 | 0.00 | 0.00 | 0.1 |
| silicone) | | | | | | | | |
| Resin Solution (low | 0.00 | 0.5 | 0.5 | 0.00 | 0.00 | 0.00 | 0.5 | 0.5 |
| molecular weight, styrene | | | | | | | | |
| acrylic alkali-soluble resin) | | | | | | | | |
| Wetting Aid 2 (Mixture: 1- | 0.00 | 0.1 | 0.00 | 0.1 | 0.00 | 0.1 | 0.00 | 0.1 |
| octyl-2-pyrrolidone, undecyl | | | | | | | | |
| alcohol + 5 EO | | | | | | | | |
| polyethoxylated, 1- | | | | | | | | |
| undecanol) | | | | | | | | |
| Fragrance (perfume) | 0.20 | 0.20 | 0.20 | 0.20 | 0.20 | 0.20 | 0.20 | 0.20 |
| Total | 19.69 | 20.29 | 20.29 | 19.89 | 19.79 | 19.79 | 20.19 | 20.39 |

TABLE 3
Chemical components (wt. %) and solids of Control A
composition for Compositions 1-8.
Control A

| Chemical Name | Wt/wt % | solids |
|---|---|---|
| Water (deionized) | 46.061 | 0 |
| Solvent 1 (diethylene glycol | 5.62 | 0 |
| ethyl ether) | | |
| Plasticizer 1 (tributoxyethyl | 1.25 | 1.25 |
| phosphate) | | |
| Plasticizer 2 (Benzoate ester | 1.75 | 1.75 |
| blend:Diethylene Glycol | | |
| Dibenzoate and Dipropylene | | |
| Glycol Dibenzoate and | | |
| Triethylene Glycol | | |
| Dibenzoate Blend) | | |
| Fluorosurfactant (partially | 0.05 | 0.02 |
| fluorinated alcohol, | | |
| ammonium salts) | | |
| Polymer Emulsion 1 (styrene | 38.089 | 14.474 |
| acrylic co polymer emulsion) | | |
| Wax Emulsion 1 (maleated | 1.875 | 0.75 |
| polypropylene wax emulsion) | | |
| Wax Emulsion 2 (oxidized | 3.6 | 1.26 |
| polyethylene wax emulsion) | | |
| Solvent 2 (ethylene glycol | 0.80 | 0 |
| phenyl ether) | | |
| Solvent 3 (ethylene glycol | 0.70 | 0 |
| hexyl ether) | | |
| Antifoam (silicone emulsion) | 0.005 | 0.0048 |
| Wetting Aid 1 (polyether | 0 | 0 |
| silicone) | | |
| Resin Solution (low | 0 | 0 |
| molecular weight, styrene | | |
| acrylic alkali-soluble resin) | | |
| Wetting Aid 2 (Mixture: | 0 | 0 |
| 1-octyl-2-pyrrolidone, undecyl | | |
| alcohol + 5 EO polyethoxylated, | | |
| 1-undecanol) | | |
| Fragrance (perfume) | 0.20 | 0.20 |
| Total | 100 | 19.71 |

TABLE 4
Chemical components (wt. %) of Compositions 9-27.
Composition Weight percentages

| Chemical Name | 9 | 10 | 11 | 12 | 13 | 14 | 15 | 16 |
|---|---|---|---|---|---|---|---|---|
| Water (conditioned, | 45.064 | 36.964 | 36.964 | 44.864 | 44.964 | 44.964 | 37.064 | 36.864 |
| tap) | | | | | | | | |
| Solvent 1 (diethylene | 5.45 | 5.45 | 5.45 | 5.45 | 5.45 | 5.45 | 5.45 | 5.45 |
| glycol ethyl ether) | | | | | | | | |
| Solvent 2 (ethylene | 0.8 | 0.8 | 0.8 | 0.8 | 0.8 | 0.8 | 0.8 | 0.8 |
| glycol hexyl ether) | | | | | | | | |
| Plasticizer 1 | 1.3 | 1.3 | 1.3 | 1.3 | 1.3 | 1.3 | 1.3 | 1.3 |
| (tributoxyethyl | | | | | | | | |
| phosphate) | | | | | | | | |
| Plasticizer 2 (2,2,4- | 2.6 | 2.6 | 2.6 | 2.6 | 2.6 | 2.6 | 2.6 | 2.6 |
| Trimethyl-1,3- | | | | | | | | |
| pentadienol | | | | | | | | |
| diisobutyrate) | | | | | | | | |
| Wetting | 0.00 | 0.00 | 0.1 | 0.1 | 0.1 | 0.00 | 0.00 | 0.1 |
| Aid/Surfactant 1 | | | | | | | | |
| (polyether silicone) | | | | | | | | |
| Wetting | 0.00 | 0.1 | 0.00 | 0.1 | 0.00 | 0.1 | 0.00 | 0.1 |
| Aid/Surfactant 2 | | | | | | | | |
| (Mixture: 1-octyl-2- | | | | | | | | |
| pyrrolidone, undecyl | | | | | | | | |
| alcohol + 5 EO | | | | | | | | |
| polyethoxylated, 1- | | | | | | | | |
| undecanol) | | | | | | | | |
| Fragrance (perfume) | 0.1 | 0.1 | 0.1 | 0.1 | 0.1 | 0.1 | 0.1 | 0.1 |
| Polymer Emulsion 1 | 35.397 | 35.397 | 35.397 | 35.397 | 35.397 | 35.397 | 35.397 | 35.397 |
| (styrene acrylic co | | | | | | | | |
| polymer emulsion) | | | | | | | | |
| Polymer/Resin 1 (low | 3.341 | 3.341 | 3.341 | 3.341 | 3.341 | 3.341 | 3.341 | 3.341 |
| molecular weight, | | | | | | | | |
| acrylic alkali-soluble | | | | | | | | |
| resin) | | | | | | | | |
| Resin Solution (low | 0.00 | 8 | 8 | 0.00 | 0.00 | 0.00 | 8 | 8 |
| molecular weight, | | | | | | | | |
| styrene acrylic alkali- | | | | | | | | |
| soluble resin) | | | | | | | | |
| Wax 1 (acrylic-olefin | 5.947 | 5.947 | 5.947 | 5.947 | 5.947 | 5.947 | 5.947 | 5.947 |
| wax grafted | | | | | | | | |
| emulsions) | | | | | | | | |

| Chemical Name | 17 | 18 | 19 | 20 | 21 | 22 |
|---|---|---|---|---|---|---|
| Water (conditioned, tap) | 44.065 | 28.865 | 36.955 | 35.965 | 36.955 | 35.965 |
| Solvent 1 (diethylene glycol ethyl ether) | 5.45 | 5.45 | 5.45 | 5.45 | 5.45 | 5.45 |
| Solvent 2 (ethylene glycol hexyl ether) | 0.8 | 0.8 | 0.8 | 0.8 | 0.8 | 0.8 |
| Plasticizer 1 (tributoxyethyl phosphate) | 1.3 | 1.3 | 1.3 | 1.3 | 1.3 | 1.3 |
| Plasticizer 2 (2,2,4-Trimethyl-1,3- | 2.6 | 2.6 | 2.6 | 2.6 | 2.6 | 2.6 |
| pentadienol diisobutyrate) | | | | | | |
| Wetting Aid/Surfactant 1 (polyether | 0.1 | 0.1 | 0.1 | 0.1 | 0.01 | 1.0 |
| silicone) | | | | | | |
| Wetting Aid/Surfactant 2 (Mixture: 1- | 0.1 | 0.1 | 0.01 | 1.0 | 0.1 | 0.1 |
| octyl-2-pyrrolidone, undecyl alcohol + 5 | | | | | | |
| EO polyethoxylated, 1-undecanol) | | | | | | |
| Fragrance (perfume) | 0.1 | 0.1 | 0.1 | 0.1 | 0.1 | 0.1 |
| Polymer Emulsion 1 (styrene acrylic co | 35.397 | 35.397 | 35.397 | 35.397 | 35.397 | 35.397 |
| polymer emulsion) | | | | | | |
| Polymer/Resin 1 (low molecular weight, | 3.341 | 3.341 | 3.341 | 3.341 | 3.341 | 3.341 |
| acrylic alkali-soluble resin) | | | | | | |
| Resin Solution (low molecular weight, | 0.8 | 16 | 8.0 | 8.0 | 8.0 | 8.0 |
| styrene acrylic alkali-soluble resin) | | | | | | |
| Wax 1 (acrylic-olefin wax grafted | 5.947 | 5.947 | 5.947 | 5.947 | 5.947 | 5.947 |
| emulsions) | | | | | | |

| Chemical Name | 23 | 24 | 25 | 26 | 27 |
|---|---|---|---|---|---|
| Water (conditioned, tap) | 44.065 | 28.865 | 36.955 | 35.965 | 36.955 |
| Solvent 1 (diethylene glycol ethyl ether) | 5.45 | 5.45 | 5.45 | 5.45 | 5.45 |
| Solvent 2 (ethylene glycol hexyl ether) | 0.8 | 0.8 | 0.8 | 0.8 | 0.8 |
| Plasticizer 1 (tributoxyethyl phosphate) | 1.3 | 1.3 | 1.3 | 1.3 | 1.3 |
| Plasticizer 2 (2,2,4-Trimethyl-1,3-pentadienol | 2.6 | 2.6 | 2.6 | 2.6 | 2.6 |
| diisobutyrate) | | | | | |
| Wetting Aid/Surfactant 1 (polyether silicone) | 0.1 | 0.1 | 0.1 | 0.1 | 1.1 |
| Wetting Aid/Surfactant 2 (Mixture: 1-octyl-2- | 0.1 | 0 | 0.1 | 0 | 0 |
| pyrrolidone,undecyl alcohol + 5 EO | | | | | |
| polyethoxylated, 1-undecanol) | | | | | |
| Fragrance (perfume) | 0.1 | 0.1 | 0.1 | 0.1 | 0.1 |
| Polymer Emulsion 1 (styrene acrylic co | 35.397 | 35.397 | 35.397 | 35.397 | 35.397 |
| polymer emulsion) | | | | | |
| Polymer/Resin 1 (low molecular weight, | 3.341 | 3.341 | 3.341 | 3.341 | 3.341 |
| acrylic alkali-soluble resin) | | | | | |
| Resin Solution (low molecular weight, styrene | 0 | 2.5 | 0 | 3.5 | 4.5 |
| acrylic alkali-soluble resin) | | | | | |
| Wax 1 (acrylic-olefin wax grafted emulsions) | 5.947 | 5.947 | 5.947 | 5.947 | 5.947 |
| Nonionic surfactant substitute | 0 | 0.1 | 0 | 1.1 | 2.1 |
| Resin substitute | 2.5 | 0 | 2.5 | 0 | 0 |

TABLE 5
Solid percentages of Compositions 9-16.
Composition Solids Percentages

| Chemical Name | 9 | 10 | 11 | 12 | 13 | 14 | 15 | 16 |
|---|---|---|---|---|---|---|---|---|
| Water (conditioned, tap) | 0.00 | 0.00 | 0.00 | 0.00 | 0.00 | 0.00 | 0.00 | 0.00 |
| Solvent 1 (diethylene glycol | 0.00 | 0.00 | 0.00 | 0.00 | 0.00 | 0.00 | 0.00 | 0.00 |
| ethyl ether) | | | | | | | | |
| Solvent 2 (ethylene glycol | 0.00 | 0.00 | 0.00 | 0.00 | 0.00 | 0.00 | 0.00 | 0.00 |
| hexyl ether) | | | | | | | | |
| Plasticizer 1 (tributoxyethyl | 1.3 | 1.3 | 1.3 | 1.3 | 1.3 | 1.3 | 1.3 | 1.3 |
| phosphate) | | | | | | | | |
| Plasticizer 2 (2,2,4- | 1.25 | 1.25 | 1.25 | 1.25 | 1.25 | 1.25 | 1.25 | 1.25 |
| Trimethyl-1,3-pentadienol | | | | | | | | |
| diisobutyrate) | | | | | | | | |
| Wetting Aid/Surfactant 1 | 0.00 | 0.00 | 0.1 | 0.1 | 0.1 | 0.00 | 0.00 | 0.1 |
| (polyether silicone) | | | | | | | | |
| Wetting Aid/Surfactant 2 | 0.00 | 0.1 | 0.00 | 0.1 | 0.00 | 0.1 | 0.00 | 0.1 |
| (Mixture: 1-octyl-2- | | | | | | | | |
| pyrrolidone, undecyl | | | | | | | | |
| alcohol + 5 EO | | | | | | | | |
| polyethoxylated, 1-undecanol) | | | | | | | | |
| Fragrance (perfume) | 0.00 | 0.00 | 0.00 | 0.00 | 0.00 | 0.00 | 0.00 | 0.00 |
| Polymer Emulsion 1 | 12.530 | 12.530 | 12.530 | 12.530 | 12.530 | 12.530 | 12.530 | 12.530 |
| (styrene acrylic co polymer | | | | | | | | |
| emulsion) | | | | | | | | |
| Polymer/Resin 1 (low | 0.112 | 0.112 | 0.112 | 0.112 | 0.112 | 0.112 | 0.112 | 0.112 |
| molecular weight, acrylic | | | | | | | | |
| alkali-soluble resin) | | | | | | | | |
| Resin Solution (low | 0.00 | 1.6 | 1.6 | 0.00 | 0.00 | 0.00 | 1.6 | 1.6 |
| molecular weight, styrene | | | | | | | | |
| acrylic alkali-soluble resin) | | | | | | | | |
| Wax 1 (acrylic-olefin wax | 2.26 | 2.26 | 2.26 | 2.26 | 2.26 | 2.26 | 2.26 | 2.26 |
| grafted emulsions) | | | | | | | | |
| Total | 17.452 | 19.152 | 19.152 | 17.652 | 17.552 | 17.552 | 19.052 | 19.252 |

TABLE 6
Chemical components (wt. %) of a Control B
composition for Compositions 9-27.
Control B

| Chemical Name | Wt/wt % | solids |
|---|---|---|
| Water (conditioned, tap) | 44.974 | 0 |
| Solvent 1 (diethylene glycol ethyl ether) | 5.45 | 0 |
| Solvent 2 (ethylene glycol hexyl ether) | 0.8 | 0 |
| Plasticizer 1 (tributoxyethyl phosphate) | 1.3 | 1.3 |
| Plasticizer 2 (2,2,4-Trimethyl-1,3- | 2.6 | 1.25 |
| pentadienol diisobutyrate) | | |
| Fluorosurfactant (partially fluorinated | 0.09 | 0.023 |
| alcohol, ammonium salts) | | |
| Wetting Aid/Surfactant 1 (polyether silicone) | 0 | 0 |
| Wetting Aid/Surfactant 2 (Mixture: | 0 | 0 |
| 1-octyl-2-pyrrolidone, undecyl alcohol + | | |
| 5 EO polyethoxylated, 1-undecanol) | | |
| Fragrance (perfume) | 0.1 | 0.1 |
| Polymer Emulsion 1 (styrene acrylic co | 35.397 | 13.451 |
| polymer emulsion) | | |
| Polymer/Resin 1 (low molecular weight, | 3.341 | 1.136 |
| acrylic alkali-soluble resin) | | |
| Resin Solution (low molecular weight, | 0 | 0 |
| styrene acrylic alkali-soluble resin) | | |
| Wax 1 (acrylic-olefin wax grafted emulsions) | 5.947 | 2.26 |
| Total | 100 | 19.52 |

Referring to Table 4 above, Compositions 9-22 vary in the chemical ingredients. In particular, Compositions 10 and 11 include one of Surfactant 1 or Surfactant 2 and Resin solution 1. Compositions 12-14 include one of or both of Surfactant 1 and Surfactant 2. Composition 15 includes Resin Solution but neither Surfactant 1 nor Surfactant 2. Composition 16 includes Surfactant 1 and Surfactant 2 and Resin Solution. Composition 17 contains low amounts of resin (i.e., Resin Solution (low molecular weight, styrene acrylic alkali-soluble resin)) while keeping the amounts of each of silicone polyether (i.e., Wetting Aid/Surfactant 1) and nonionic surfactant (i.e., Wetting Aid/Surfactant 2 (a mixture of 1-octyl-2-pyrrolidone, undecyl alcohol+5 EO polyethoxylated, 1-undecanol)) constant as compared to, for example, Composition 16. Composition 18 contains high amounts of resin (i.e., Resin Solution (low molecular weight, styrene acrylic alkali-soluble resin)) while keeping the amounts of each of silicone polyether (i.e., Wetting Aid/Surfactant 1) and nonionic surfactant (i.e., Wetting Aid/Surfactant 2 (a mixture of 1-octyl-2-pyrrolidone, undecyl alcohol+5 EO polyethoxylated, 1-undecanol)) constant as compared to, for example, Composition 16. Composition 19 contains low amounts of nonionic surfactant (i.e., Wetting Aid/Surfactant 2 (a mixture of 1-octyl-2-pyrrolidone,undecyl alcohol+5 EO polyethoxylated, 1-undecanol)) while keeping the amounts of each of silicone polyether (i.e., Wetting Aid/Surfactant 1) and resin (i.e., Resin Solution (low molecular weight, styrene acrylic alkali-soluble resin)) constant as compared to, for example, Composition 16. Composition 20 contains high amounts of nonionic surfactant (i.e., Wetting Aid/Surfactant 2 (a mixture of 1-octyl-2-pyrrolidone,undecyl alcohol+5 EO polyethoxylated, 1-undecanol)) while keeping the amounts of each of silicone polyether (i.e., Wetting Aid/Surfactant 1) and resin (i.e., Resin Solution (low molecular weight, styrene acrylic alkali-soluble resin)) constant as compared to, for example, Composition 16. Composition 21 contains low amounts of silicone polyether (i.e., Wetting Aid/Surfactant 1) while keeping the amounts of each of resin (i.e., Resin Solution (low molecular weight, styrene acrylic alkali-soluble resin)) and nonionic surfactant (i.e., Wetting Aid/Surfactant 2 (a mixture of 1-octyl-2-pyrrolidone,undecyl alcohol+5 EO polyethoxylated, 1-undecanol)) constant as compared to, for example, Composition 16. Composition 22 contains high amounts of silicone polyether (i.e., Wetting Aid/Surfactant) while keeping the amounts of each of resin (i.e., Resin Solution (low molecular weight, styrene acrylic alkali-soluble resin)) and nonionic surfactant (i.e., Wetting Aid/Surfactant 2 (a mixture of 1-octyl-2-pyrrolidone, undecyl alcohol+5 EO polyethoxylated, 1-undecanol)) constant as compared to, for example, Composition 16.

Table 5 lists the specific chemicals used in Compositions 9-16 as a percent solid. For instance, after application of Composition 10 to a floor, approximately 80.85% of the composition evaporates, leaving approximately 19.15% of the composition on the floor applied thereto. As a result, Composition 10 has a composition solid percent and/or percent solid of about 19.15%.

Table 6 lists the specific chemicals used in a control composition for comparison to Compositions 9-16.

### Testing

The Compositions 1-16 and the controls were subjected to testing as follows, according to a modification of ASTM Standard D3153-17 “Standard Test Method for Recoatability of Water-based Floor Polishes.” As used herein, the terms “leveling” or “level” or “streak” rating or performance refers to results of the below described testing procedure. Personnel evaluating the floor finish results include a technical professional, (i.e., lab technician, chemist, product evaluator or product technical support from the company), and an end-user (i.e., people that buy and use the product or those that experience the product in the real world such as a janitor, facility manager, customer or visitor of the facility). As part of the test, the personnel rank the floor finish as poor, fair and good in terms of appearance. In the modification of this test, the sensitivity of the scale is modified to include end-user perception as well as the perception of the technical professional.

Multiple coats were applied until a defect was observed, or 10 coats were applied, whichever came first. The aesthetics of the resulting surface were evaluated based on gloss and defects (e.g., streaks, craters, etc.) in comparison to a standard finish containing fluorinated components. The floor finish was then graded according to the scale of 0 (not different from standard finish), 1 (slight difference vs standard, noticeable by a technical professional), 2 (moderately different vs standard, noticeable by end users), or 3 (significantly different vs standard, noticeable by end users). Negative (minus) values indicate results performing worse than the standard. Positive (plus) values indicate results performing better than the standard.

The floor finish compositions of the present disclosure had results similar to compositions of fluorosurfactants. More particularly, the results from the testing are shown in Tables 7 and 8 below, and as shown therein, the compositions having the substitute fluorosurfactant system (i.e., Composition 8 and Composition 16) resulted in leveling results comparable to compositions having fluorosurfactants. Additionally, the results showcase the unexpected nature and synergistic effects of the components of the substitute system. More particularly, the compositions having none of the components of the substitute system, one component of the substitute system, or two components of the substitute system had lower ratings, while the combination of the components unexpectedly created high ratings comparable to compositions having fluorosurfactants.

TABLE 7
Leveling test results for Control A and Compositions 1-8.

| Experiment/ | | |
|---|---|---|
| Composition | Description | Leveling Rating (Lab, RT) |
| Control A | partially fluorinated | 0 (streak) after 10 coats |
| | alcohol, ammonium salts | |
| | (Fluorosurfactant) | |
| 1 | No silicone surfactant, | −3 (streak) after 10 coats |
| | no resin, no nonionic | |
| | surfactant | |
| 2 | No silicone surfactant | −3 (streak) after 10 coats |
| 3 | No nonionic surfactant | −3 (streak) after 10 coats |
| 4 | No resin | −2 (streak) after 10 coats |
| 5 | No resin, no nonionic | −3 (streak) after 10 coats |
| | surfactant | |
| 6 | No silicone surfactant, | −3 (streak) after 10 coats |
| | no resin | |
| 7 | No silicone surfactant, | −3 (streak) after 10 coats |
| | no nonionic surfactant | |
| 8 | Contains silicone | 0 (streak) after 10 coats |
| | polyether, pyrrolidone, | |
| | and low molecular weight | |
| | styrene acrylic | |
| | alkali-soluble resin | |

TABLE 8
Leveling test results for Control B and Compositions 9-27.

| Experiment/ | | Leveling Rating |
|---|---|---|
| Composition | Description | (Lab, RT) |
| Control B | Partially fluorinated alcohol, | 0 (streak) after 5 coats |
| | ammonium salts | |
| | (Fluorosurfactant) | |
| 9 | No silicone surfactant, no | −3 (streak) after 5 coats |
| | resin, no nonionic surfactant | |
| 10 | No silicone surfactant | −3 (streak) after 5 coats |
| 11 | No nonionic surfactant | −3 (streak) after 5 coats |
| 12 | No resin | −2 (streak) after 5 coats |
| 13 | No resin, no nonionic | −3 (streak) after 5 coats |
| | surfactant | |
| 14 | No silicone surfactant, | −3 (streak) after 5 coats |
| | no resin | |
| 15 | No silicone surfactant, no | −3 (streak) after 5 coats |
| | nonionic surfactant | |
| 16 | Contains silicone polyether, | 0 (streak) after 5 coats |
| | pyrrolidone, and low molecular | |
| | weight styrene acrylic | |
| | alkali-soluble resin | |
| 17 | Low resin | 0 |
| 18 | High resin | −2 |
| 19 | Low ionic surfactant | −2 |
| 20 | High nonionic surfactant | −3 |
| 21 | Low silicone polyether | −2 |
| 22 | High silicone polyether | −2 |
| 23 | A non-alkaline soluble resin | −1 |
| 24 | Alternative resin with Mol. | −1 |
| | Wgt. <20,000 Da | |
| 25 | Mol. Wgt more than 20,000 Da | −2 |
| 26 | Alternative resin with a Mol. | −1 |
| | Wgt. >20,000 Da | |
| 27 | Alternative nonionic | −2 |
| | surfactant (TDA-3) | |

### Example 2

Additional surfactants and surfactant blends were also tested to determine their potential in substitute fluorosurfactant systems. More particularly, several surfactants were tested in isolation (i.e., without another surfactant or resin solution) within the prior formulations, several surfactants were tested in combination, and several surfactants were tested in combination with a resin solution. The results of this testing are shown in Tables 9, 10, and 11 below. The compositions were graded according to the scale of 0 (not different from standard finish), 1 (slight difference vs standard, noticeable by a technical professional), 2 (moderately different vs standard, noticeable by end users), or 3 (significantly different vs standard, noticeable by end users). Negative (minus) values indicate results performing worse than the standard. Positive (plus) values indicate results performing better than the standard.

Tables 9, 10, and 11 showcase the improved results or ratings of compositions of the present disclosure, and in particular, the substitute fluorosurfactant system disclosed herein. More so, the results shown in Tables 9-11 demonstrate the synergistic effects of the components of the substitute fluorosurfactant system and the beneficial effects that each component of the system has. Last, the results help exhibit that multiple surfactants may be used in the substitute fluorosurfactant system and the substitute fluorosurfactant system is not limited to the particular surfactants listed in the aforementioned examples.

TABLE 9
Leveling test results for combinations of components present
in the substitute fluorosurfactant system disclosed herein.

| Composition | Leveling Rating (Lab, RT) |
|---|---|
| Siloxane-based gemini | −2 (streak) after 4 coats |
| surfactant | |
| Water-soluble ester, silicone | −2 (streak) after 6 coats |
| free, anionic | |
| Blend of non-ionic surfactants | −1.5 (streak) after 8 coats |
| Polyether-modified | −1.5 (streak) after 8 coats |
| polydimethylsiloxane | |
| N-Octyl-2-Pyrrolidone | 1.5 (crater) after 3 coats |

TABLE 10
Leveling test results for combinations of components present
in the substitute fluorosurfactant system disclosed herein.

| | | Leveling Rating |
|---|---|---|
| First Surfactant | Second Surfactant | (Lab, RT) |
| Hyper-branched Star | polyether silicone | −1 (streak) |
| polymer with organo- | | after 10 coats |
| modified polysiloxanes | | |
| Hyper-branched Star | Mixture: | −1.5 (streak) |
| polymer with organo- | 1-octyl-2-pyrrolidone, | after 10 coats |
| modified polysiloxanes | undecyl alcohol + | |
| | 5 EO polyethoxylated, | |
| | 1-undecanol | |
| Disodium Capryloampho- | polyether silicone | −1 (streak) |
| dipropionate | | after 10 coats |
| amphoteric surfactant | | |
| Low molecular weight | Mixture: | −1.5 (streak) |
| nonionic silicone | 1-octyl-2-pyrrolidone, | after 10 coats |
| polyether surfactant | undecyl alcohol + | |
| | 5 EO polyethoxylated, | |
| | 1-undecanol | |
| Organomodified | — | −2 (streak) |
| silicone | | after 10 coats |
| Mixture: | Siltech C570 | −1.5 (streak) |
| 1-octyl-2-pyrrolidone, | | after 10 coats |
| undecyl alcohol + | | |
| 5 EO polyethoxylated, | | |
| 1-undecanol | | |
| Polyether modified | Mixture: | −1 (streak) |
| siloxane | 1-octyl-2-pyrrolidone, | after 10 coats |
| | undecyl alcohol + | |
| | 5 EO polyethoxylated, | |
| | 1-undecanol | |

TABLE 11
Leveling test results for combinations of components present
in the substitute fluorosurfactant system disclosed herein.

| | Second | | Leveling Rating |
|---|---|---|---|
| Composition | Surfactant | Resin | (Lab, RT) |
| Disodium | polyether silicone | low molecular weight, | −1 (streak) |
| Capryloamphodipropionate | | styrene acrylic | after 10 coats |
| amphoteric surfactant | | alkali-soluble resin | |
| Low molecular weight | Mixture: | low molecular weight, | 0 (streak) |
| nonionic silicone | 1-octyl-2-pyrrolidone, | styrene acrylic | after 10 coats |
| polyether surfactant | undecyl alcohol + | alkali-soluble resin | |
| | 5 EO polyethoxylated, | | |
| | 1-undecanol | | |
| Organomodified Silicone | Mixture: | low molecular weight, | 0 (streak) |
| | 1-octyl-2-pyrrolidone, | styrene acrylic | after 10 coats |
| | undecyl alcohol + | alkali-soluble resin | |
| | 5 EO polyethoxylated, | | |
| | 1-undecanol | | |
| Mixture: | polyether silicone | low molecular weight, | 0 (streak) |
| 1-octyl-2-pyrrolidone, | | styrene acrylic | after 10 coats |
| undecyl alcohol + | | alkali-soluble resin | |
| 5 EO polyethoxylated, | | | |
| 1-undecanol | | | |

### Example 3

Tables 12-15 show comparisons between various control, comparative, and inventive compositions disclosed herein. The compositions underwent performance testing for gloss, black heel marks/scuffs, and leveling.

The indicated compositions and controls were subjected to gloss performance testing according to “Standard Test Method for 60° Specular Gloss of Emulsion Floor Polish” of ASTM D1455-87, which is incorporate, in its entirety, by reference herein. Further, the indicated compositions and controls were subjected to black heel marks/scuff testing according to a modification of ASTM procedure D 3714-87 Standard Test Method for Black Marking Resistance of Floor Polishes as Measured by the Ladder and Pendulum Apparatus, which is incorporated, in its entirety, by reference herein. Briefly, the testing includes coating a standard tile for comparative testing, placing 6 rubber cubes in a programmable Snell capsule and 6 tiles in the tile holders, programming the Snell capsule for 10 seconds duration in each direction for 30 cycles at 60 rpm. Test products are compared to standard products in black heel mark and scuff resistance using a standardized scale: where 0 (not different from standard finish), 1 (slight difference vs standard, noticeable by a technical professional), 2 (moderately different vs standard, noticeable by end users), or 3 (significantly different vs standard, noticeable by end users). Negative (minus) values indicate results performing worse than the standard. Positive (plus) values indicate results performing better than the standard.

As shown in Table 12, inventors formulated and tested a blank composition lacking the substitute fluorosurfactant system disclosed herein (i.e., each of a silicone polyether, a resin, and a nonionic surfactant.

TABLE 12
Gloss, black heel marks/scuffs, and leveling performance
test results for a blank formulation.

| | | Black Heel | |
|---|---|---|---|
| Composition | Gloss | Marks/Scuffs | Leveling |
| Control A | 0 | 0 | 0 |
| Blank Formulation (no resin, no | −3 | −2 | −3 |
| silicone polyether, no nonionic | | | |
| surfactant) | | | |

TABLE 13
Gloss, black heel marks/scuffs, and leveling performance
test results for Control A, Composition 8 (lacking an
antifoaming agent), and a Modified Composition 8.

| | | Black Heel | |
|---|---|---|---|
| Composition | Gloss | Marks | Leveling |
| Modified Composition 8 | −0.5 | −0.5 | −0.5 |
| formulated where Wetting | | | |
| Aid 1 (polyether silicone) | | | |
| is Sylgard OFX 0309 | | | |
| Control A | −0.5 | 0 | 0 |
| Composition 8 formulated | 0 | 0 | 0 |
| without an antifoaming agent; | | | |
| and where Wetting Aid 1 | | | |
| (polyether silicone) is | | | |
| not Sylgard OFX 0309 | | | |

As shown in Table 14, the substitute fluorosurfactant system disclosed herein did not to produce similar performance results (e.g., gloss, black heel marks, leveling, etc) when formulated with a percent solids that a traditional fluorosurfactant-based floor finish composition may contain (i.e., a high percent solids).

TABLE 14
Gloss, black heel marks/scuffs, and leveling performance test
results for Control B and Composition 28 as shown in Table 15.

| | Solids | | Black Heel | |
|---|---|---|---|---|
| Composition | Content | Gloss | Marks | Leveling |
| Control B | ~22.5% | 0 | 0 | 0 |
| 28 | ~22.5% | −3 | −1 | −2.5 |

TABLE 15
The composition and solids content of composition
28 (no wetting aid) as disclosed in Table 14.

| | | Solids |
|---|---|---|
| Chemical Name | Composition 28 | Content |
| Water (conditioned, tap) | 45.064 | 0 |
| Solvent 1 (diethylene glycol | 5.450 | 0 |
| ethyl ether) | | |
| Solvent 2 (ethylene glycol | 0.800 | 0 |
| hexyl ether) | | |
| Plasticizer 1 (tributoxyethyl | 1.30 | 1.3 |
| phosphate) | | |
| Plasticizer 2 (2,2,4-Trimethyl- | 2.600 | 1.25 |
| 1,3-pentadienol diisobutyrate) | | |
| Wetting Aid/Surfactant 1 | 0.00 | 0 |
| (polyether silicone) | | |
| Wetting Aid/Surfactant 2 | 0.00 | 0 |
| (Mixture: 1-octyl-2-pyrrolidone, | | |
| undecyl alcohol + 5 EO | | |
| polyethoxylated, 1-undecanol) | | |
| Fragrance (perfume) | 0.10 | 0 |
| Polymer Emulsion 1 (styrene | 35.3974 | 12.530 |
| acrylic co polymer emulsion) | | |
| Polymer/Resin 1 (low | 3.341 | 0.112 |
| molecular weight, acrylic | | |
| alkali-soluble resin) | | |
| Resin Solution (low molecular | 0.00 | 0 |
| weight, styrene acrylic | | |
| alkali-soluble resin) | | |
| Wax 1 (acrylic-olefin wax | 5.947 | 2.260 |
| grafted emulsions) | | |
| Total | 100 | 17.452 |

Table 16 shows a comparison between a fluorosurfactant-free commercial floor cleaner formulation. Control A. and Control B.

TABLE 16
Gloss, black heel marks/scuffs, and leveling performance
test results for compositions disclosed herein, and a
fluorosurfactant-free commercial floor cleaning composition.

| | Solids | | Black Heel | |
|---|---|---|---|---|
| Composition | content | Gloss | Marks | Leveling |
| Control A | ~20% | 0 | 0 | 0 |
| Commercial Floor Cleaner | ~17.5% | −2 | −3 | −1 |
| (Fluorosurfactant free) | | | | |
| Control B | ~22.5% | 0 | 0 | 0 |

It is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention. The exclusive rights to all modifications which come within the scope of the appended claims are reserved.

1. A composition for a floor finish, comprising:
a silicone polyether surfactant;
a nonionic surfactant; and
a resin.

2. The composition of claim 1, wherein the silicone polyether is a nonionic silicone polyether surfactant.

3. The composition of claim 1, wherein the nonionic surfactant is a capryl pyrrolidone or a polyethylene glycol monoundecyl ether.

4. The composition of claim 1, wherein the resin is an alkaline soluble resin.

5. The composition of claim 1, wherein the resin has an average molecular weight less than about 20,000 Da.

6. The composition of claim 1, wherein the resin is comprised of a styrene acrylic oligomer.

7. The composition of claim 1, wherein the composition further comprises a carrier.

8. The composition of claim 7, wherein the composition comprises about 30 wt. % to about 50 wt. % of the carrier, wherein weight percent is based on the total weight of the composition.

9. The composition of claim 7, wherein the carrier is water.

10. The composition of claim 1, further comprising at least one solvent, at least one polymer, at least one plasticizer, at least one wax, and a fragrance.

11. The composition of claim 1, wherein the silicone polyether surfactant comprises about 0.05 wt. % to about 0.25 wt. %, wherein weight percent is based on the total weight of the composition.

12. The composition of claim 1, wherein the nonionic surfactant comprises about 0.05 wt. % to about 0.25 wt. %, wherein weight percent is based on the total weight of the composition.

13. The composition of claim 1, wherein the resin comprises about 2.0 wt. % to about 8.5 wt. %, wherein weight percent is based on the total weight of the composition.

14. The composition of claim 1, wherein
the silicone polyether surfactant comprises about 0.01 wt. % to about 1.0 wt. %;
the nonionic surfactant comprises about 0.01 wt. % to about 1.0 wt. %; and
the resin comprises about 0.8 wt. % to about 16.0 wt. %;
wherein weight percent is based on the total weight of the composition.

15. The composition of claim 1, wherein
the silicone polyether surfactant comprises about 0.1 wt. %;
the nonionic surfactant comprises about 0.1 wt. %; and
the resin comprises about 8 wt. %;
wherein weight percent is based on the total weight of the composition.

16. The composition of claim 1, wherein
the silicone polyether surfactant comprises about 0.1 wt. %;
the nonionic surfactant comprises about 0.1 wt. %; and
the resin comprises about 2.5 wt. %;
wherein weight percent is based on the total weight of the composition.

17. The composition of claim 1, wherein the composition is substantially free of a fluorochemical.

18. The composition of claim 17, wherein the fluorochemical is a fluorosurfactant.

19. A composition for a floor finish, the composition including:
a mixture that includes one or more surfactants and a resin,
wherein the composition is substantially free of fluorosurfactants, and
wherein a leveling testing value of the composition is comparable to a control composition identical to the composition, except for a fluorosurfactant is used in place of the mixture.

20. A method of finishing floors, comprising:
contacting a floor with the composition of claim 1.
